(19) United States
(12) Patent Application Publication
(10) Pub. No.: US 2023/0194928 A1
(43) Pub. Date: Jun. 22, 2023

(54) ASYMMETRIC LIQUID CRYSTAL PANEL WITH REDUCED MURA, INSULATED GLAZING UNITS AND WINDOWS INCORPORATING SAME

(71) Applicant: CORNING INCORPORATED, Corning, NY (US)

(72) Inventors: Oladapo Olalekan Bello, Horseheads, NY (US); James Gregory Couillard, Ithaca, NY (US); Michael Aaron McDonald, Painted Post, NY (US); Paul George Rickerl, Endicott, NY (US)

(21) Appl. No.: 17/922,511

(22) PCT Filed: Apr. 27, 2021
(86) PCT No.: PCT/US2021/029280

§ 371 Date: Oct. 31, 2022

Related U.S. Application Data
(60) Provisional application No. 63/018,931, filed on May 1, 2020.

(51) Int. Cl. G02F 1/1337

(52) U.S. Cl. CPC G02F 1/1337

(57) ABSTRACT

The described embodiments relate generally to asymmetric liquid crystal panels with improved properties and tailored characteristics, including insulated glazing units and liquid crystal windows incorporating such panels. A liquid crystal cell having thin glass is incorporated into an asymmetric thin liquid crystal panel comprising a pane bonded to the first sheet of the liquid crystal cell via an adhesive layer bonding the first sheet to the pane wherein the liquid crystal material is controllable to adjust a transmittance of the liquid crystal panel.

### CROSS-REFERENCE TO RELATED APPLICATIONS

This application claims the benefit of priority under 35 U.S.C. § 119 of U.S. Provisional Application No. 63/018,931 filed May 1, 2020, the content of which is incorporated herein by reference in its entirety.

### FIELD OF THE DISCLOSURE

The described embodiments relate generally to liquid crystal (LC) panels for use in insulated glazing units (IGUs) and liquid crystal windows. In particular, embodiments relate to asymmetric liquid crystal panels with reduced mura for use in IGUs and liquid crystal windows.

### BACKGROUND

Smart, switchable or dimmable glass (e.g. for use in smart, switchable or dimmable windows) is a glass or glazing whose light transmission properties are altered when voltage, light, or heat is applied. In general, the glass changes from transparent to translucent and vice versa, changing from letting light pass through to blocking some (or all) wavelengths of light and vice versa. Smart glass technologies include electrochromic, photochromic, thermochromic, suspended-particle, micro-blind, and polymer-dispersed liquid-crystal devices. Smart windows can be used to control light transmission through the window, thereby improving occupant comfort and reducing energy costs.

In liquid crystal windows, liquid crystals are placed between layers of glass or plastic. The windows change between clear or transparent, darkened or tinted and/or opaque states depending on the alignment or misalignment of the liquid crystals with the application of voltage. In some liquid crystal windows, a guest-host mixture is prepared by mixing liquid crystals and dichroic dyes. When the liquid crystal molecules change their orientation, they induce the dye molecules to follow. The dichroic dyes absorb light preferentially in one direction, such as when the electric field of the incident light is perpendicular to the long axis of the dye. Hence light transmission through the liquid crystal window can be modulated by controlling the absorption axis of the dye molecules via orientation of the liquid crystal molecules. For example, the molecules are oriented parallel to one or more glass surfaces resulting in high degree of absorption of light incident normal to the glass surface. In those liquid crystal windows when a voltage is applied to the electrodes, the electric field formed between the two electrodes causes the molecules to align perpendicular to the glass, allowing light to pass through the droplets with very little absorption and resulting in a transparent state. The degree of transparency can be controlled by the applied voltage. It is also possible to further control the amount of light and heat passing through, when tints and special inner layers are used.

Smart window development involves balancing a number of desired properties, e.g. strength, lightness, efficiency and aesthetic appeal. For example, smart windows need sufficient strength to withstand exposure to the wind and snow loads commonly experienced by windows in architectural applications. At the same time, they need optical and electrical properties that provide the desired visual properties, e.g. clarity and opacity in the various dimmed states.

Previous liquid crystal cells used thick soda lime glass (SLG) on either side of the liquid crystal material. These liquid crystal cells could further be incorporated in symmetric liquid crystal panel configurations, i.e. having the same type of glass on either side of the liquid crystal cell. For example, such a symmetric configuration is shown at FIG. 1. For example, a prior symmetric configuration could have thick (>3 mm), annealed SLG 120 on both sides of a wide cell gap (>20 μm) 130 containing the liquid crystal material 140. The symmetric liquid crystal panel 100 incorporates two pieces of thick (>3 mm) tempered soda lime glass 150 laminated with adhesive 160 to the previously formed liquid crystal cell 110. They could also be made in asymmetric configuration (not shown), i.e. having a pane of glass 150 on only one side of the liquid crystal cell 110. For example, a prior asymmetric configuration could have thick (>3 mm), annealed SLG 120, with a wide cell gap (>20 μm) 130, laminated to a single pane of thick (>3 mm), tempered SLG 150. However, the resulting smart windows made from these thick, SLG liquid crystal cells were thick and heavy, making them difficult to transport and install. The large glass thickness also reduced the available space for gas in an insulated glazing unit, thereby reducing the insulation efficiency.

Optical problems also existed with the liquid crystal panels discussed above. Specifically, a defect known as mura was noted in such liquid crystal panels. Mura refers to local non-uniformity in optical properties of the panel. Mura often appears as light or dark spots and can have the characteristics of low contrast, blurry edge, uncertain size and non-uniform background.

A technical solution is desired to address problems associated with mura in liquid crystal panels while also maintaining strength against external forces (e.g. weather), lightness for ease of transport/installation and window efficiency.

### SUMMARY

In some embodiments, the present liquid crystal panel comprises (1) a liquid crystal cell comprising a first sheet, a second sheet, and a liquid crystal material disposed between the first sheet and the second sheet; (2) a pane bonded to the first sheet of the liquid crystal cell; and (3) an adhesive layer bonding the first sheet to the pane where the liquid crystal material is controllable to adjust a visible light transmittance of the liquid crystal panel

In some embodiments, the liquid crystal panel has local variation across a first or second inner surface of less than about 1 μm. In some embodiments, the liquid crystal panel has variation in visible light transmission across its first outer surface in a clear or darkened state of less than about 2.5%.

In some embodiments, at least one of the first and second sheet has a waviness of less than about 60 nm. In some embodiments, at least one of the first sheet and the second sheet is a fusion formed glass sheet. In some embodiments, at least one of the first sheet and the second sheet has a thickness of about 0.3 mm to about 1.0 mm.

In some embodiments, the first sheet and the second sheet of the liquid crystal cell are arranged substantially parallel to and spaced from each other to define a cell gap therebetween, and the liquid crystal material is disposed within the cell gap. The cell gap can have a thickness of less than 15 μm.

In some embodiments, the pane is a glass pane. In some embodiments, the pane is a strengthened glass pane. For example, it can be made of soda lime glass. In some embodiments, the pane has a thickness of about 2 mm to about 12 mm.

In some embodiments the adhesive layer comprises a polymeric adhesive that blocks ultraviolet (UV) light. In some embodiments, the adhesive layer has a thickness of about 0.7 to about 1.5 mm.

In some embodiments, the liquid crystal panel further comprises a first conductive layer disposed between the first sheet and the liquid crystal material; and a second conductive layer disposed between the second sheet and the liquid crystal material.

In some embodiments, the liquid crystal panel further comprises a first alignment layer disposed between the first sheet and the liquid crystal material; and a second alignment layer disposed between the second sheet and the liquid crystal material.

In some embodiments the liquid crystal material comprises a polymer dispersed liquid crystal (PDLC) material, a guest host liquid crystal material, a cholesteric liquid crystal material, a chiral liquid crystal material, a nematic liquid crystal material, or a combination thereof.

In some embodiments, the liquid crystal panel has a thickness of about 15 mm or less.

In some embodiments, the present liquid crystal panel is incorporated into an insulated glazing unit comprising: the liquid crystal panel; a second pane; and a spacer disposed between the liquid crystal panel and the second pane such that a cavity is disposed between the liquid crystal panel and the second pane and is substantially circumscribed by the spacer.

In some embodiments, the present insulated glazing unit has variation in visual light transmission across its outer surfaces in a clear or darkened state of less than about 2.5%.

In some embodiments, the second pane is a glass pane. In some embodiments, the second pane is a strengthened glass pane. For example, it can be made of soda lime glass and can be tempered. In some embodiments, the second pane has a thickness of about 2 mm to about 12 mm. In some embodiments, the second pane is a laminated glass pane.

In some embodiments, the insulated glazing unit further comprises a low-e coating on a surface of the second pane.

In some embodiments, the thickness of the insulated glazing unit is under about 20 mm.

In some embodiments, the insulated glazing unit further comprises a seal disposed between the liquid crystal panel and the second pane and circumscribing the cavity. In some embodiments, the insulated glazing unit further comprises a gas disposed within the cavity.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 shows a cross-sectional schematic of a symmetric liquid crystal panel.

FIG. 2 shows a contour map of tempered soda lime glass.

FIG. 3 shows a cross-sectional schematic of an asymmetric liquid crystal panel according to an embodiment of the invention.

FIG. 4A-C shows a cross-sectional schematics of an insulated glazing units incorporating an asymmetric liquid crystal panel according to embodiments of the invention.

FIG. 5 shows roughness and waviness as measures of surface micro-corrugation.

FIG. 6 shows a cross-sectional schematic of a smart window incorporating an asymmetric liquid crystal panel according to an embodiment of the invention.

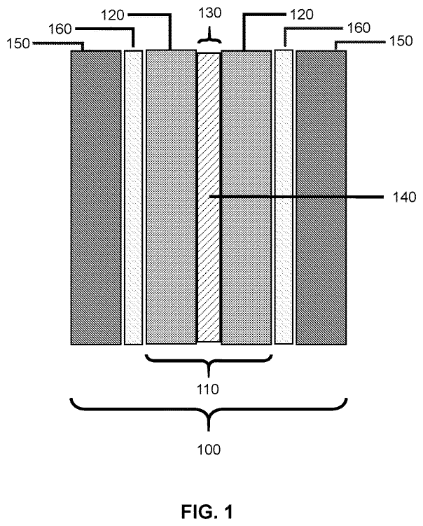

### DETAILED DESCRIPTION

Applicant has developed liquid crystal cells with liquid crystal material sandwiched between two pieces of thin glass (e.g. typically <1 mm) to form a liquid crystal cell with a narrow cell gap (e.g. less than 25 microns). For example, thin glass can include alumino borosilicate glass or soda lime glass. These liquid crystal cells can then be laminated with a thick pane on at least one side of the thin liquid crystal cell. Without being bound by any particular mechanism or theory, this configuration is believed to result in a liquid crystal panel of sufficient strength (e.g. for exterior fenestration applications) with improved bow properties and thinner, lighter overall structure. One or more embodiments provided herein provide advantageous, uniquely tailored properties and/or performance characteristics as compared to previous liquid crystal window structures.

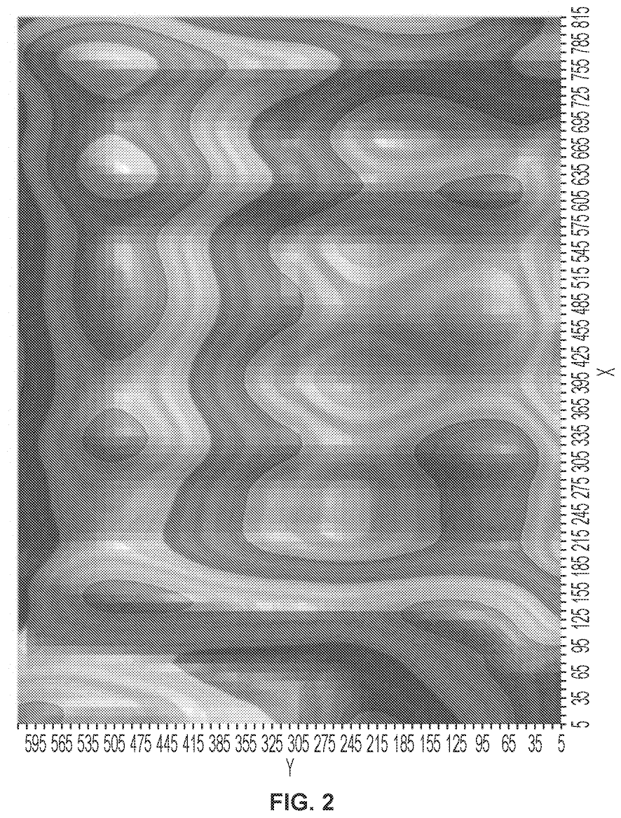

As also discussed above, Applicant noted that mura problems existed with the previous liquid crystal panels. Without wishing to be bound by theory, it is believed that out-of-plane distortion of the strengthened panes, i.e. thick, tempered layers of soda lime glass may contribute to the presence of mura in resulting liquid crystal panels. For example, the tempering process can induce out-of-plane distortion in the soda lime glass, which can be significant (e.g. as compared to planar or flat surfaces). This is shown, for example, in FIG. 2, which shows a contour map of representative piece of tempered soda lime glass. FIG. 2 shows peaks and troughs on the surface of thick, tempered soda lime glass averaging ˜50 μm peak-to-valley height. When two panes (i.e., sheets of soda lime glass) are used on either side of the liquid crystal cell gap in a symmetric configuration, they have different peaks and troughs in out-of-plane distortion. It is believed that the different peaks and troughs from out-of-plane distortion can contribute as mura considerations in that the additive effect of multiple panes with surface aberrations/out-of-plane distortion can act to exacerbate the pulling and pushing on the liquid crystal material and create or contribute to the undesirable local changes in visual appearance (e.g. in the form of mura and/or other visually observable disparities/non-uniformities).

This effect is further exacerbated when a thin liquid crystal cell is laminated to a thick pane (e.g. a thick tempered soda lime glass pane) for strength. It is believed that, after lamination, if the thin glass from the LC cell is well-adhered to the pane (i.e., tempered soda lime glass) the out-of-plane distortion can pull on the thin glass, which locally increases the liquid crystal cell gap and produces undesirable local changes in visual appearance in the form of mura. When two panes (i.e., sheets of tempered soda lime glass) are used on either side of the liquid crystal cell in a symmetric configuration, they have different peaks and troughs in out-of-plane distortion. It is believed that the different peaks and troughs from out-of-plane distortion exacerbate the pulling and pushing on the thin glass of the liquid crystal cell gap and create the undesirable local changes in visual appearance in the form of mura.

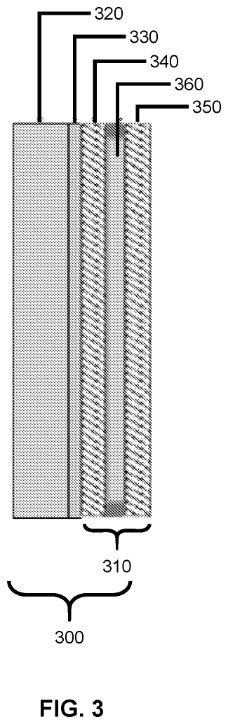

In various aspects of the present disclosure, embodiments to minimize the effect of the out-of-plane distortion on the thin liquid crystal cell include utilizing an asymmetric liquid crystal panel design that only contains one pane (e.g. piece of thick glass and/or piece of soda lime glass) with a liquid crystal cell incorporating thin glass as shown in FIG. 3. The elimination of one glass ply (e.g. thick glass ply and/or glass ply having out-of-plane distortion) reduces the negative impact of the out-of-plane surface on the liquid crystal cell and positively improves the mura and/or dark spots. The elimination of the second layer of out-of-plane distortion, e.g. from soda lime glass, reduces the degree of liquid crystal cell deformation thereby eliminating the mura and/or dark spots in the finished liquid crystal panel. One or more of the asymmetric liquid crystal panel embodiments described herein are believed to have improved optical properties (e.g. reduced mura and/or dark spots, higher visible light transmission in the clear or transparent state and reduced optical distortion) while also maintaining strength against external forces (e.g. weather), lightness for ease of transport/installation, and window efficiency (due to additional room for gas in insulated glazing unit), as compared to the aforementioned described liquid crystal panels.

FIG. 3 shows a cross-sectional schematic of an asymmetric liquid crystal panel according to an embodiment of the invention 300. In some embodiments, liquid crystal panel 300 comprises a liquid crystal cell 310 bonded to a pane 320 via an adhesive 330. The liquid crystal cell 310 comprises a first sheet 340, a second sheet 350, and a liquid crystal material 360 disposed between the first sheet 340 and the second sheet 350. The liquid crystal material 360 is controllable to adjust a transmittance of the liquid crystal panel 300.

In some embodiments, liquid crystal panel 300 is configured as a sheet. For example, liquid crystal panel 300 has a thickness, a width, and a length, with the width being greater than the thickness, and the length being greater than or equal to the width. In such embodiments, each of the width and the length can be substantially greater than the thickness. For example, each of the width and the length is at least 10 times, at least 100 times, or at least 1000 times greater than the thickness. The sheet can be planar or substantially planar (e.g., flat). Alternatively, the sheet can be non-planar (e.g., curved).

First sheet 340 comprises a first surface and a second surface opposite the first surface. A thickness of first sheet 340 is the distance between first surface and second surface. Second sheet 350 comprises a first surface and a second surface opposite the first surface. A thickness of second sheet 350 is a distance between first surface and second surface. In some embodiments, first sheet 340 is a relatively thin sheet. Additionally, or alternatively, second sheet 350 is a relatively thin sheet. For example, first sheet 340 and/or second sheet 350 have a thickness of about 1 mm or less, about 0.9 mm or less, about 0.8 mm or less, or about 0.7 mm or less. Additionally, or alternatively, first sheet 340 and/or second sheet 350 have a thickness of about 0.05 mm or more, about 0.1 mm or more, about 0.2 mm or more, about 0.3 mm or more, about 0.4 mm or more, or about 0.5 mm or more. For example, first sheet 340 and/or second sheet 350 have a thickness of about 0.3 mm to about 1.0 mm, preferably about 0.5 mm. The thicknesses of first sheet 340 and second sheet 350 can be the same or different.

In some embodiments, first sheet 340 and/or second sheet 350 comprise or are formed from a glass material, a ceramic material, a glass-ceramic material, a polymeric material, or a combination thereof. In some embodiments, the first sheet 340 and/or second sheet 350 comprise a glass having a low coefficient of thermal expansion (CTE). In some embodiments, first sheet 340 and/or second sheet 350 comprise an aluminosilicate glass. Additionally, or alternatively, first sheet 340 and/or second sheet 350 comprise an alkali-free glass that is free or substantially free of alkali metals and components comprising alkali metals. For example, the alkali-free glass comprises 0.1 mol % or less, 0.05 mol % or less, or 0.01 mol % or less R₂O, expressed on an oxide basis, where R is one or more of Li, Na, or, K. The alkali-free glass can help to avoid alkali migration from first sheet 340 and/or second sheet 350 into liquid crystal material 360, thereby avoiding alkali materials screening the liquid crystal material from an applied voltage and maintaining the performance of the liquid crystal material. In some embodiments, first sheet 340 and/or second sheet 350 comprise an alkali-containing glass that comprises alkali metals or compounds comprising alkali metals. For example, the alkali-containing glass comprises 1 mol % or more, 5 mol % or more, or 10 mol % or more R₂O, expressed on an oxide basis, where R is one or more of Li, Na, or, K. Additionally, or alternatively, the alkali-containing glass is an alkali aluminosilicate glass. The compositions of first sheet 340 and second glass 350 can be the same or different.

In some embodiments, first sheet 340 and second sheet 350 are spaced from each other to define a cell gap therebetween, and liquid crystal material 360 is disposed within the cell gap. Additionally, or alternatively, first sheet 340 and second sheet 350 are arranged substantially parallel to each other. A thickness of the cell gap is a distance between second surface of first sheet 340 and first surface 350 of second sheet. In some embodiments, the cell gap has a thickness of about 15 μm or less, about 14 μm or less, about 13 μm or less, about 12 or less, about 11 μm or less, or about 10 μm or less. Additionally, or alternatively, the cell gap has a thickness of about 4 μm or more. For example, the cell gap has a thickness of about 4 μm to about 12 μm, or about 10 μm. In a preferred embodiment, the thickness of the cell gap can be uniform (e.g., in embodiments in which first sheet 340 and second sheet 350 are arranged substantially parallel to each other).

The performance of liquid crystal material 360 can be sensitive to the spacing between first sheet 340 and second sheet 350. In some embodiments, first sheet 340 and second sheet 350 have precise thickness uniformity and/or surface smoothness to enable precise and uniform spacing to enable desirable performance of liquid crystal material 360. For example, first sheet 340 and/or second sheet 350 are fusion formed glass sheets. For example, first sheet 340 and/or second sheet 350 are fusion formed glass sheets commercially available as EAGLE XG® glass substrates from Corning Incorporated® (Corning, N.Y.) or flexible glass sheets commercially available as Willow® Glass from Corning Incorporated (Corning, N.Y.). Such fusion formed glass sheets can exhibit the desired thickness uniformity and surface characteristics to enable desirable liquid crystal material performance. Fusion formed glass sheets can be identified by the presence of a fusion line therein resulting from fusion of separate layers of glass into a single glass sheet during forming.

In order to enhance precise thickness uniformity and/or surface smoothness to enable precise and uniform spacing to enable desirable performance of liquid crystal material, the first sheet 340 and/or second sheet 350 are configured to be precisely smooth and flat, e.g. minimal out-of-plane distortion. One way of quantifying out-of-plane distortion in glass is to evaluate the surface's waviness and/or roughness. “Microcorrugation” is a term that includes both waviness and roughness.

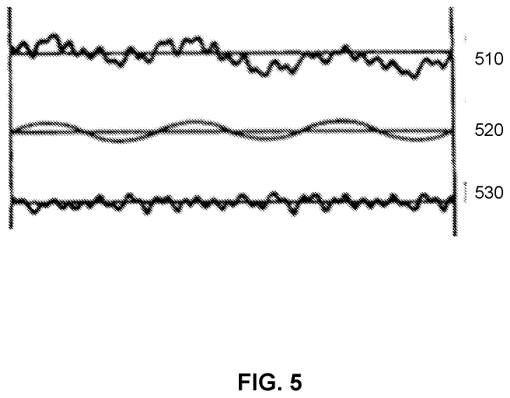

FIG. 5 shows the differences between waviness 520 and roughness 530 in a surface and how both appear together on a surface 510. As depicted in FIG. 5, 510 depicts a representative surface profile, as measured using contact stylus profilometer or non-contact optical interferometer. The X-axis denotes a given distance along the surface, and Y-axis denotes height (where distance and height are provided in arbitrary units). The surface profile 510, thus includes two representative components: designated as waviness 520 and roughness 530.

As used herein, one way to minimize/improve out-of-plane distortion is to measure/quantify waviness. A method and ranges for quantifying waviness are defined in SEMI D15-1296, “FPD Glass Substrate Surface Waviness Measurement Method.” As referenced here, waviness is quantified in accordance with SEMI D15-1296.

In some embodiments, the first sheet 340 and/or second sheet 350 have a waviness (as measured by a contact profilometer over a wavelength range of 0.8˜8 mm) of about 200 nm or less, about 150 nm or less, about 100 nm or less, about 75 nm or less or about 50 nm or less. Additionally, or alternatively, the first sheet 340 and/or second sheet 350 have a waviness (as measured by a contact profilometer over a wavelength range of 0.8˜8 mm) of about 30 nm or more, about 35 nm or more, about 40 nm or more or about 45 nm or more. The first sheet 340 and second sheet 350 can have the same waviness or different waviness.

When surface roughness or roughness is referenced herein, it is referring to average surface roughness, as measured in accordance with ASME B46.1, utilizing an atomic force microscope. In some embodiments, the first sheet 340 and/or second sheet 350 have a roughness (as measured by an atomic force microscope) of about 1 nm, about 0.8 nm or less, about 0.6 nm or less, or about 0.4 nm.

In some embodiments, liquid crystal material 360 defines a liquid crystal layer disposed between first sheet 340 and second sheet 350. In some embodiments, liquid crystal layer has a thickness of about 15 μm or less, about 14 μm or less, about 13 μm or less, about 12 μm or less, about 11 μm or less, or about 10 μm or less. Additionally, or alternatively, the liquid crystal layer has a thickness of about 4 μm or more. For example, the liquid crystal layer has a thickness of about 4 μm to about 12 μm, or about 10 μm. The thickness of the liquid crystal layer can be uniform.

Liquid crystal material 360 can be manipulated (e.g., by subjecting the liquid crystal material to an electric field, e.g. actuate a high contrast/low contrast states) to adjust a transmittance of the liquid crystal material, thereby adjusting a transmittance of liquid crystal panel 300. The liquid crystal material may be combined with one or more carriers, dyes, additives, surfactants, spacers, etc.

In some embodiments, the liquid crystal cell 310 comprises a first conductive layer disposed between first sheet 340 and liquid crystal material 360. Additionally, or alternatively, the liquid crystal cell 310 comprises a second conductive layer disposed between second sheet 350 and liquid crystal material 360. Thus, first conductive layer and/or second conductive layer can be disposed within the cell defined between first sheet 340 and second sheet 350. In some embodiments, first conductive layer and/or second conductive layer comprises or is formed from a transparent conductor material.

In some embodiments, liquid crystal cell 310 comprises a first alignment layer disposed between first sheet 340 and liquid crystal material 360. Additionally, or alternatively, liquid crystal cell 310 comprises a second alignment layer disposed between second sheet 350 and liquid crystal material 360. First alignment layer and second alignment layer can help to orient molecules of liquid crystal material 360 at a particular angle (e.g., a pretilt angle) relative to the respective alignment layer.

In some embodiments, liquid crystal cell comprises a sealant disposed between first sheet 340 and second sheet 350. The sealant can substantially circumscribe liquid crystal material 360, which can help to retain the liquid crystal in place between first sheet 340 and second sheet 350 and/or protect the liquid crystal material from environmental exposure that could damage the liquid crystal material.

A thickness of liquid crystal cell 310 is a distance between outer surfaces of the liquid crystal cell. In some embodiments, liquid crystal cell 310 has a thickness of about 1.5 mm or less, about 1.4 mm or less, about 1.3 mm or less, about 1.2 mm or less, about 1.1 mm or less, or about 1 mm or less. Additionally, or alternatively, liquid crystal cell 310 has a thickness of about 0.1 mm or more, about 0.2 mm or more, about 0.3 mm or more, about 0.4 mm or more, about 0.5 mm or more, about 0.6 mm or more, about 0.7 mm or more, about 0.8 mm or more, about 0.9 mm or more, or about 1 mm or more. The relatively thin first sheet 340 and second sheet 350 can enable liquid crystal cell 310 to have a reduced thickness compared to conventional liquid crystal cells. Such a reduced thickness of liquid crystal cell 310 can enable a reduced thickness of a liquid crystal panel 300 and/or an IGU comprising the liquid crystal panel.

As discussed above, Applicant noted that mura problems existed with the prior symmetric liquid crystal panels incorporating thin liquid crystal cells and that such problems appear to result from out-of-plane distortion of the two strengthening panes, i.e. thick, tempered layers of soda lime glass. FIG. 2, shows a contour map of tempered soda lime glass, which exhibits the out-of-plane distortion showing peaks and troughs on the surface averaging ˜50 μm peak-to-valley height. Applicant's novel method to minimize the effect of the out-of-plane distortion on the thin liquid crystal cell is to utilize an asymmetric liquid crystal panel design that only contains one pane (e.g. piece of soda lime glass) as shown in FIG. 3. The elimination of one glass ply reduces the negative impact of the out-of-plane surface on the liquid crystal cell and positively improves the mura and/or dark spots (e.g. reduces, prevents, and/or eliminates the presence of mura and/or visually observable disparities or non-uniformities). The elimination of the second layer of out-of-plane distortion, e.g. from soda lime glass, reduces the degree of liquid crystal cell deformation thereby eliminating the mura and/or dark spots in the finished liquid crystal panel.

In accordance with the benefits discussed above, one or more embodiments of the liquid crystal panels 300 described herein have relatively constant distance between the inner surfaces of panes 340 and 350 (e.g. promoting a uniform cell gap, minimizing visual non-uniformities). A first outer surface of the liquid crystal panel 300 is the first surface of the pane 320 (i.e., the surface not bonded to the first sheet 340). A second outer surface of the liquid crystal panel is the second surface of second sheet 350 (i.e. the surface not facing the liquid crystal material 360). Specifically, local variation in the spacing between the inner surfaces of panes 340 and 350 is less than about 1 μm, less than about 0.9 μm, less than about 0.8 μm, less than about 0.7 μm, less than about 0.6 μm, less than about 0.5 μm, less than about 0.4 μm, less than about 0.3 μm or less than about 0.2 μm.

In accordance with the benefits discussed above, one or more embodiments of the liquid crystal panels 300 described herein have relatively limited variation in visual light transmission across the first outer surface in one or more states. A first outer surface of the liquid crystal panel 300 is the first surface of the pane 320 (i.e., the surface not bonded to the first sheet 340). Specifically, variation in visual light transmission across the first outer surface in the clear or transparent, darkened or tinted and/or opaque states is less than about 2.5%, less than about 2.25% μm, less than about 2%, less than about 1.75%, less than about 1.5% or less than about 1%.

In some embodiments, liquid crystal cell 310 is bonded to a pane 320 as shown in FIG. 3. For example, pane 320 is bonded to first sheet 340 (e.g., first surface of the first sheet). In some embodiments, pane 320 is configured as a sheet. Thus, pane 320 comprises a first surface and a second surface opposite the first surface. A thickness of pane 320 is the distance between first surface and second surface.

In some embodiments, pane 320 is a relatively thick panel. For example, pane 320 has a thickness of about 2 mm or more, about 2.5 mm or more, about 3 mm or more, about 3.5 mm or more, or about 4 mm or more. Additionally, or alternatively, pane 320 has a thickness of about 12 mm or less, about 11 mm or less, about 10 mm or less, about 9 mm or less, about 8 mm or less, about 7 mm or less, about 6 mm or less, about 5 mm or less, or about 4 mm or less. For example, pane 320 has a thickness of about 3 mm to about 6 mm.

In some embodiments, pane 320 comprises or is formed from a glass material, a ceramic material, a glass-ceramic material, a polymeric material, or a combination thereof (e.g. laminate). In some embodiments, pane 320 comprises soda lime glass. In some embodiments, pane 320 is a strengthened glass pane. For example, pane 320 is a thermally tempered glass pane.

In some embodiments, pane 320 is bonded to first sheet 340 with an adhesive layer 330. In some embodiments, adhesive layer 330 comprises a polymeric adhesive. For example, adhesive layer 330 comprises polyvinyl butyral (PVB), ethylene vinyl acetate (EVA), thermoplastic polyurethane (TPU), an ionomer, an ionoplast, or a combination thereof. Additionally, or alternatively, adhesive layer 330 blocks ultraviolet (UV) light.

Pane 320 can be bonded to first glass sheet 340 using a suitable lamination process. For example, adhesive layer 330 is applied to pane 320 and/or first sheet 340 by roll coating, curtain coating, or another suitable coating or printing process, and the pane, the adhesive layer, and the first sheet are positioned in a stack. In some embodiments, liquid crystal cell 310 is formed prior to bonding pane 320 thereto. Thus, the stack comprises pane 320, adhesive layer 330, first sheet 340, liquid crystal material 360 and second sheet 350. In some embodiments, air is removed from the stack using a variety of methods including nip rollers, evacuated pouches, vacuum rings, or a flatbed laminator. In some embodiments, the stack is preliminarily laminated using a flatbed laminator (e.g., in a de-air and tack process) or another suitable laminator. Additionally, or alternatively, the stack is bonded in an autoclave or another suitable heating and/or pressing apparatus.

In some embodiments, adhesive layer 330 has a thickness of about 2.3 mm or less, about 2.0 mm or less, about 1.7 mm or less, about 1.5 mm or less, about 1.2 mm or less, or about 1.0 mm or less. Additionally, or alternatively, adhesive layer 330 has a thickness of about 0.3 mm or more, about 0.4 mm or more, about 0.5 mm or more, about 0.6 mm or more, about 0.7 mm or more, about 0.8 mm or more, or about 0.9 mm or more. For example, adhesive layer 330 can have a thickness of about 0.76 mm to about 1.52 mm.

A thickness of liquid crystal panel is a distance between outer surfaces of the liquid crystal panel. For example, in the embodiments shown in FIG. 3, the thickness of liquid crystal panel 300 is a distance between first surface of pane 320 and second surface of second sheet 350. In some embodiments, liquid crystal panel 300 has a thickness of about 11 mm or less, about 10 mm or less, about 9 mm or less, about 8 mm or less, about 7 mm or less, or about 6 mm or less. Additionally, or alternatively, liquid crystal panel 300 has a thickness of about 5 mm or more, about 6 mm or more, or about 7 mm or more.

In some embodiments, the liquid crystal panel has applications in residential buildings (e.g. IGU or window), commercial buildings (e.g. IGU or window), and transportation products/windows (e.g. automobile, train, truck, boat, or the like). In some embodiments, the width of liquid crystal panel 300 is 48 inches or less, 46 inches or less, 44 inches or less, 42 inches or less, 40 inches or less, 38 inches or less, or 36 inches or less. Additionally, or alternatively, a length of liquid crystal panel is 60 inches or less, 55 inches or less, 50 inches or less, 45 inches or less, or 40 inches or less. The width of liquid crystal panel 300 and the length of liquid crystal panel 300 can be the same or different.

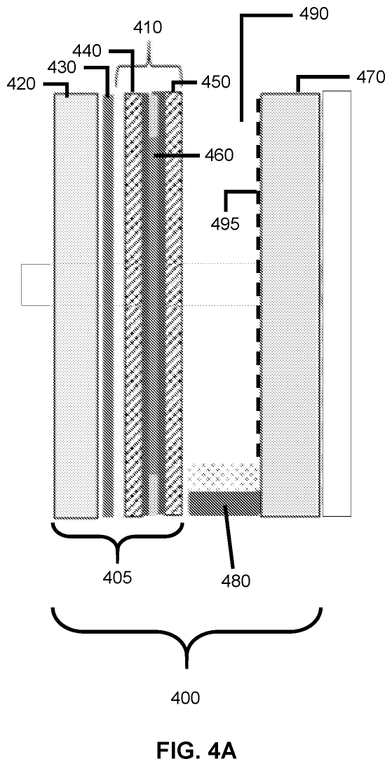

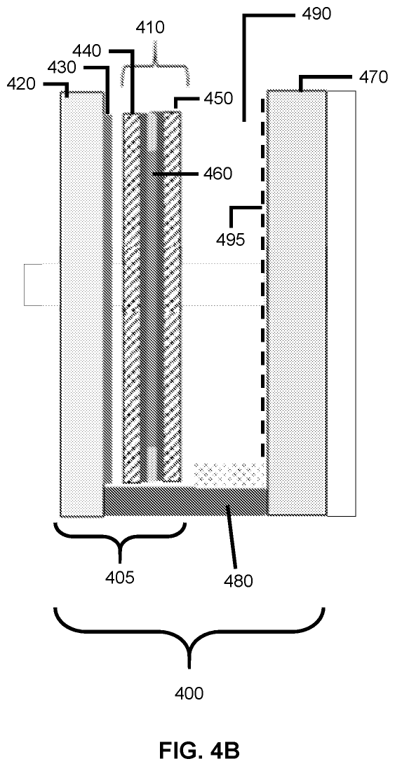

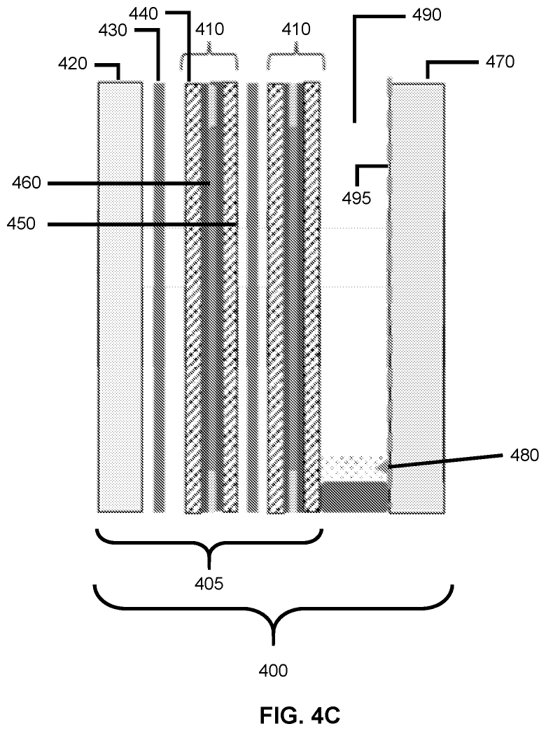

FIG. 4 is a cross-sectional schematic view of some embodiments of an IGU 400 comprising liquid crystal panel 405 (also shown as 300 from FIG. 3). IGU 400 comprises a second pane 470 and a spacer 480 disposed between liquid crystal panel 405 and the second pane 470 such that a cavity 490 is disposed between the liquid crystal panel 405 and the second pane. In some embodiments, second pane 470 can be configured as described herein in reference to pane 420. For example, second pane 470 is a sheet comprising a first surface, a second surface opposite the first surface, and a thickness extending between the first surface and the second surface. Additionally, or alternatively, second pane 470 can be a relatively thick panel as described herein. Additionally, or alternatively, second pane 470 can be a strengthened glass sheet. In some embodiments, IGU 400 comprises a single liquid crystal cell (e.g., liquid crystal cell 410), in a single cell IGU as shown in FIGS. 4A and 4B. In other embodiments, IGU 400 comprises two liquid crystal cells (e.g., liquid crystal cell 410), in a double cell IGU as shown in FIG. 4C.

In some embodiments, spacer 480 substantially circumscribes cavity 490. For example, spacer 480 comprises a frame disposed near the edges of liquid crystal panel 405 and second pane 470 and extending substantially entirely or entirely around a perimeter of cavity 490. Spacer 480 can promote and/or maintain separation between liquid crystal panel 405 and second pane 470. Thus, a thickness of spacer 480 can be substantially equal to a thickness of cavity 490. In some embodiments, spacer 480 comprises a metallic material, a polymeric material, a glass material, a ceramic material, a glass-ceramic material, or a combination thereof. For example, spacer 480 comprises a metal or metallic material, like aluminum or an aluminum alloy.

In some embodiments, cavity 490 comprises a gas disposed therein. For example, cavity 490 comprises air, nitrogen, neon, argon, krypton, or a combination thereof disposed therein. In other embodiments, cavity 490 comprises at least a partial vacuum drawn therein. The gas or vacuum in cavity 490 can reduce the conduction of heat through the cavity, thereby reducing the conduction of heat through IGU 400. Such reduced conduction of heat can increase the insulating efficiency of the IGU, which can be beneficial in architectural applications (e.g., exterior building windows) and/or transportation applications (e.g. automotive, trucking, boat, aerospace, and/or train windows).

In some embodiments, IGU 400 comprises a seal. For example, a seal can be disposed between liquid crystal panel 405 and second pane 470. Additionally, or alternatively, the seal circumscribes or substantially circumscribes cavity 490 and/or spacer 480. Seal 480 can help to prevent gas within cavity 480 from escaping the cavity and/or prevent atmospheric gas and/or liquid from entering the cavity, thereby helping to maintain the insulating properties of IGU 400. In some embodiments, seal 480 comprises a silicone material.

In some embodiments, IGU 400 comprises a low-e coating layer 495. In some of such embodiments, low-e coating layer 495 is disposed on a surface of second pane 470. For example, low-e coating layer 495 is disposed on first surface of second pane 470. In other embodiments, the low-e coating layer is disposed on the liquid crystal panel 300 (e.g., second surface of second sheet 450).

In some embodiments, the relatively thin liquid crystal panel 405 can enable IGU 400 to have a reduced thickness compared to an IGU with a thicker liquid crystal panel (e.g. as described above). In some embodiments, the thickness of cavity 490 is about 12 mm or more, and the thickness of IGU 400 is about 25 mm or less, about 24 mm or less, about 23 mm or less, about 22 mm or less, about 21 mm or less, about 20 mm or less, about 19 mm or less, or about 18 mm or less.

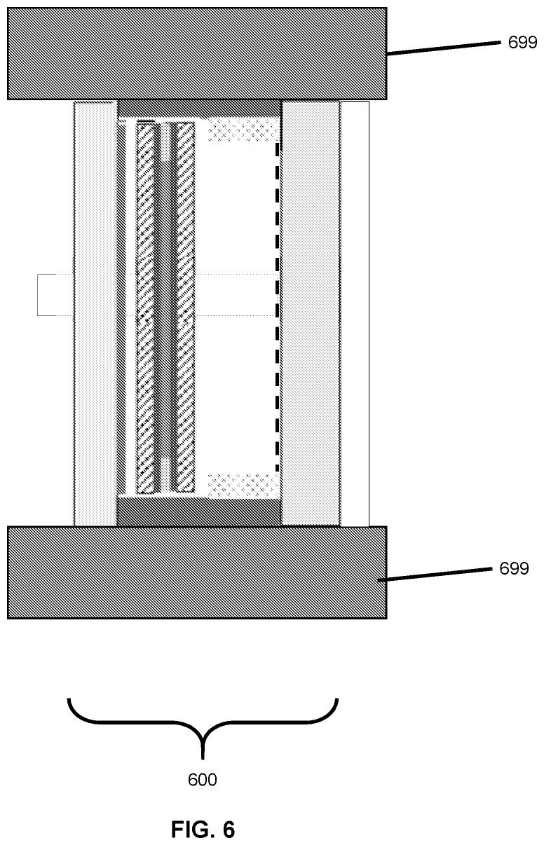

FIG. 6 shows a cross-sectional schematic of smart window 600 incorporating an asymmetric liquid crystal panel according to an embodiment of the invention. Framing 699 can be added to the single or double IGUs discussed above and shown in FIG. 4 to form a smart liquid crystal window according to embodiments of the present invention.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end- point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

As used herein, “comprising” is an open-ended transitional phrase. A list of elements following the transitional phrase “comprising” is a non-exclusive list, such that elements in addition to those specifically recited in the list may also be present.

The term “or,” as used herein, is inclusive; more specifically, the phrase “A or B” means “A, B, or both A and B.” Exclusive “or” is designated herein by terms such as “either A or B” and “one of A or B,” for example.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

The term “wherein” is used as an open-ended transitional phrase, to introduce a recitation of a series of characteristics of the structure.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments, but should be defined only in accordance with the following claims and their equivalents.

1. A liquid crystal panel, comprising:
a liquid crystal cell comprising
a first sheet,
a second sheet, and
a liquid crystal material disposed between the first sheet and the second sheet;
a pane bonded to the first sheet of the liquid crystal cell; and
an adhesive layer bonding the first sheet to the pane;
wherein the liquid crystal material is controllable to adjust a visible light transmittance of the liquid crystal panel)

2. The liquid crystal panel of claim 1 having local variation across a first or second inner surface of less than 1 μm.

3. The liquid crystal panel of claim 1 having variation in visible light transmission across its first outer surface in a clear or darkened state of less than 2.5%.)

4. The liquid crystal panel of any of claim 1, wherein at least one of the first and second sheet has a waviness of less than 60 nm.

5. The liquid crystal panel of claim 1, wherein at least one of the first sheet and the second sheet is a fusion formed glass sheet.

6. The liquid crystal panel of claim 1, wherein at least one of the first sheet and the second sheet has a thickness of 0.3 mm to about 1.0 mm.

7. The liquid crystal panel of claim 1, wherein the first sheet and the second sheet of the liquid crystal cell are arranged substantially parallel to and spaced from each other to define a cell gap therebetween, and the liquid crystal material is disposed within the cell gap.

8. The liquid crystal panel of claim 7, wherein the cell gap has a thickness of less than 15 μm.

9. The liquid crystal panel of claim 1, wherein the pane is a glass pane.

10. The liquid crystal panel of claim 1, wherein the pane is a strengthened glass pane.

11. The liquid crystal panel of claim 1, wherein the pane is made of soda lime glass.

12. The liquid crystal panel of claim 1, wherein the pane has a thickness of 2 mm to 12 mm.

13. The liquid crystal panel of claim 1, wherein the adhesive layer comprises a polymeric adhesive that blocks ultraviolet (UV) light.

14. The liquid crystal panel of claim 1, wherein the adhesive layer has a thickness of 0.7 to 1.5 mm.

15. The liquid crystal panel of claim 1, further comprising:
a first conductive layer disposed between the first sheet and the liquid crystal material; and
a second conductive layer disposed between the second sheet and the liquid crystal material.

16. The liquid crystal panel of claim 1, further comprising:
a first alignment layer disposed between the first sheet and the liquid crystal material; and
a second alignment layer disposed between the second sheet and the liquid crystal material.

17. The liquid crystal panel of claim 1, wherein the liquid crystal material comprises a polymer dispersed liquid crystal (PDLC) material, a guest host liquid crystal material, a cholesteric liquid crystal material, a chiral liquid crystal material, a nematic liquid crystal material, or a combination thereof.

18. The liquid crystal panel of claim 1, wherein the thickness is 15 mm or less.

19-29. (canceled)
